(19) United States
(12) Patent Application Publication
(10) Pub. No.: US 2024/0082832 A1
(43) Pub. Date: Mar. 14, 2024

(54) Self-Disinfecting Photocatalyst Sheet With Primer

(71) Applicant: Aleddra Inc., Renton, WA (US)

(72) Inventors: Chia-Yiu Maa, Bellevue, WA (US); Li-Jyuan Luo, Taipei City (TW); Chun-Te Yu, Bellevue, WA (US)

(21) Appl. No.: 18/388,778

(22) Filed: Nov. 10, 2023

Related U.S. Application Data
(63) Continuation-in-part of application No. 17/352,296, filed on Jun. 19, 2021, now Pat. No. 11,850,316.
Application No. 17/352,296 is a continuation-in-part of application No. 17/027,535, filed on Sep. 21, 2020.

(51) Int. Cl. B01J 35/00; B01J 21/06; B01J 23/50

(52) U.S. Cl. CPC B01J 35/004; B01J 21/063; B01J 23/50

(57) ABSTRACT

A self-disinfecting photocatalyst sheet includes a substrate material, a photocatalyst layer, and a primer. The photocatalyst layer comprises a primary photocatalyst and a secondary photocatalyst. The primary photocatalyst is anatase titanium dioxide and the secondary photocatalyst comprises a metallic photocatalyst. The secondary photocatalyst absorbs a visible light energy, transfers the energy to the primary photocatalyst, thus activating the primary photocatalyst as the primary disinfecting agent. The substrate material binds the photocatalyst layer by either connecting the primary photocatalyst and/or the secondary photocatalyst through two oxygen atoms of a carboxyl group (COO) comprising the primer, or by forming hydrogen bonds between the carbonyl group and a surface hydroxyl group (OH—) of the primary photocatalyst. The self-disinfecting photocatalyst sheet is activatable by a visible light and can self-disinfect against bacteria and viruses.

### CROSS-REFERENCE TO RELATED PATENT APPLICATION(S)

The present disclosure is a continuation-in-part (CIP) of U.S. patent application Ser. No. 17/352,296, filed 19 Jun. 2021, which itself is a CIP of U.S. patent application Ser. No. 17/027,535, filed 21 Sep. 2020, the contents of which being incorporated by reference in their entirety herein.

### BACKGROUND

### Technical Field

The present disclosure pertains to the field of antimicrobial photocatalyst device and, more specifically, proposes a self-disinfecting photocatalyst sheet with primer.

### Description of Related Art

In U.S. patent application Ser. No. 17/352,296, a self-disinfecting photocatalyst sheet was introduced. It includes a substrate material with a first side and a second side, a photocatalyst layer with a primary photocatalyst and a secondary photocatalyst, and a primer between the substrate material and the photocatalyst layer. The primer contains either carboxyl groups or carbonyl groups. The primary photocatalyst is anatase titanium dioxide (TiO2) having a rhombus-shape comprising a major axis 10-15 nm and a minor axis 3-6 nm. The secondary photocatalyst comprises a metallic photocatalyst, selected from silver, gold, copper, zinc, nickel, cerium, or a combination thereof. The mass ratio of the primary photocatalyst to the secondary photocatalyst is between 10:1 to 100:1. The secondary photocatalyst absorbs a visible light energy, transfers the energy to the primary photocatalyst, thus activating the primary photocatalyst as the primary disinfecting agent. The substrate material binds the photocatalyst layer by either connecting the primary photocatalyst and/or the secondary photocatalyst through two oxygen atoms of a carboxyl group (COO) comprising the primer, or by forming hydrogen bonds between the carbonyl group and a surface hydroxyl group (OH—) of the primary photocatalyst.

The technical requirements on the primary photocatalyst's shape (having rhombus-shape) and size (having a major axis 10-15 nm and a minor axis 3-6 nm) and on the mass ratio of the primary photocatalyst to the secondary photocatalyst being between 10:1 to 100:1 are very strict. It will be shown that it is possible to form a photocatalyst layer using a anatase TiO2, with a different shape and a different size, as the primary photocatalyst and using a different mass ratio of the primary photocatalyst to the secondary photocatalyst for achieving a similar effect of having the secondary photocatalyst absorbing a visible light energy, transferring the energy to the primary photocatalyst, thus activating the primary photocatalyst as the primary disinfecting agent. Thus consequently, the requirements on the primary photocatalyst's shape and size may be adjusted and the requirement on the range of the mass ratio of the primary photocatalyst to the secondary photocatalyst may be expanded.

### SUMMARY

To explore and compare the photocatalyst materials suitable for making self-disinfecting photocatalyst sheet with primer under visible light condition, two photocatalyst sol-gel samples, Sample A and Sample B, are prepared, as shown in FIG. 1. For Sample A, its primary photocatalyst is rhombus-shape anatase TiO2 with a major axis 10-15 nm and a minor axis 3-6 nm, and its secondary photocatalyst is silver nanoparticles. Sample A's mass ratio of TiO2 to silver nanoparticles is 30:1. For Sample B, its primary photocatalyst is anatase TiO2 having a round-shape having a diameter around 40-60 nm. Sample B's mass ratio of TiO2 to silver nanoparticles is 6.7:1. Both samples are prepared in a 30 ml solution, then going through 24-hour freezing at 0° C., followed by 96-hour vacuum freeze-drying method. The concentration of the purified Sample A or Sample B in the dispersion (in terms of mg mL-1) is determined by the vacuum drying method. The particle concentration of Sample A is 9.83 mg/mL, and the particle concentration of Sample B is 3.38 mg/mL. It is noted that the particle concentration of Sample A is 290% of the particle density of Sample B.

FIG. 2 shows the results of FE-SEM analysis of these two samples. For Sample A, the mass ratio between Ti and Ag is 20.58% to 1.36% (or 15:1), whereas for Sample B, the mass ratio between Ti and Ag is 1.35% to 0.33% (or 4:1). These results are in line with the mass ratio of TiO₂ to Ag being 30:1 for Sample A and the mass ratio of TiO₂ to Ag being 6.7:1 for Sample B. For conducting FE-SEM analysis effectively, C and Au are added in Sample A and Sample B. They do not affect the mass ratio between the Ti and Ag and they are not used in the subsequent methylene blue (MB) degradation experiments. FIG. 3A, FIG. 3B, and FIG. 3C respectively show the images of the photocatalyst particles of Sample B at a lower magnification (×33,000), at a higher magnification (×65000), and at a higher magnification with a different view (×65,000). The size of the photocatalyst particles of Sample B averages around 51.7 nm. The photocatalyst particle size of Sample A is too small to be seen with FE-SEM analysis. The TEM and the HRTEM images of the photocatalyst comprising rhombus-shape anatase TiO2 with a major axis 10-15 nm and a minor axis 3-6 nm and silver nanoparticles can be seen in FIG. 2 of “Antiviral and Antibacterial Effects of Silver-Doped TiO2 Prepared by the Peroxo Sol-Gel Method” by Benjawan Moongraksathurn et al. in Journal of Nanoscience and Nanolechnology Vol. 19, pp. 7356-7362, 2019.

To further confirm the photocatalyst particle size difference between Samples A and B, Dynamic Light Scattering (DLS) analysis is used, and the results are shown in FIG. 4. It can be seen from FIG. 4 that the median cumulant diameter of the photocatalyst particles of Sample A is 21.1 nm, whereas median cumulant diameter of the photocatalyst particles of Sample B is 49.2 nm, which is in line with the FE-SEM observations of Sample B (51.7±3.3 nm). Also shown in FIG. 4 is the DLS analysis of silver nanoparticles (Ag NPs) solution sample, which is used as a baseline material for comparing the visible-light photocatalytic effectiveness of Samples A and B.

It is well known that methylene blue (MB) degradation is an effective means in demonstrating the photocatalytic effectiveness of a photocatalyst in response to a UV light or a visible light. See https://pubs.acs.org/doi/10.1021/acsomega.1c03195, https://www.sciencedirect.com/science/article/abs/pii/S0926337300002769, and https://www.sciencedirect.com/science/article/abs/pii/S074960361000128X for reference. FIG. 5 shows the results of MB degradation using Sample A, Sample B, Ag NPs, and MB only (showing the natural degradation of MB). FIG. 5A shows MB degradation when samples are exposed with 365 nm UV light at 20 cm distance. It is evident that both Samples A and B demonstrate effective photocatalytic behavior with significant MB degradation, whereas Ag NPs shows no photocatalytic behavior when compared to the natural degradation of MB. FIG. 5B shows MB degradation when exposed to 3433K white light at 819 lux. Both Samples A and B demonstrate photocatalytic behavior with MB degradation, though not as strong as when they are exposed to UV light. Ag NPs again shows no photocatalytic behavior. FIG. 5C shows MB degradation when exposed to 5000K white light at 312 lux. Both Samples A and B demonstrate photocatalytic behavior with MB degradation, though not as strong as when they are exposed to UV light. Ag NPs again shows no photocatalytic behavior when compared to the natural degradation of MB.

In all three MB degradation experiments, the MB degradation effectiveness of Sample A is slightly better than that of Sample B. This is due to that TiO₂ particles in Sample A have a smaller particle size and a higher volume density, thus resulting in more TiO₂ particles absorbing the visible light energy transferred from the Ag NPs. However, the smaller particle size of TiO₂ is not the only determining factor. K. Balachandran et al. demonstrates in their research paper “Synthesis and Characterization of Ag-decorated TiO₂ Nanoparticles for Photocatalytic Application” in Journal of Environmental Nanotechnology, Vol. 10(4), pp. 13-18, 2021, that the surface of TiO₂—Ag NP also plays an important role in the absorption and transferring of the visible light energy. In Appendix, the calculation of the total surface of cumulant TiO₂—Ag NP is shown for Sample A in volume density 9.83 mg/ml . . . 1.93×10¹⁷ nm²), Sample B in volume density 3.38 mg/mL (=1.96×10¹⁸ nm²), and Sample B in volume density 9.83 mg/mL (=5.76×10¹⁸ nm²). This could explain why Sample A with a much higher volume density (9.83 mg/mL) is only slightly better in photocatalytic effectiveness (in terms of MB degradation) as compared to Sample B at a much lower volume density (3.38 mg/mL). This is because the total surface area of TiO₂—Ag NPs in Sample B at the volume density 3.38 mg/mL has more than 10 times the surface area of TiO₂—Ag NPs in Sample A at the volume density 9.83 mg/mL. If the volume density of Sample B is adjusted to be the same as Sample A (i.e., at 9.83 mg/mL), then the total surface area of TiO₂—Ag NPs in Sample B becomes 5.76×10¹⁸ nm², almost 30 times of the surface area of TiO₂—Ag NPs in Sample A. Thus it can be expected that the photocatalytic effectiveness of Sample B is much better than that of Sample A at the same volume density.

It is evident that Sample B comprising round-shape anatase TiO₂ exhibits photocatalytic behavior in response to visible light. Therefore, regarding claim 1 of U.S. patent application Ser. No. 17/352,296, its technical requirement on the shape (having rhombus-shape) is no longer required. Moreover, its technical requirement on the size (having a major axis 10-15 nm and a minor axis 3-6 nm) of the primary photocatalyst TiO₂ may be adjusted to larger particle sizes. Sample B further demonstrates that with a mass ratio of TiO₂ to silver nanoparticles at 6.7:1 in the photocatalyst sol-gel, more silver nanoparticles can absorb more visible light energy, transfer more energy to the primary photocatalyst anatase TiO₂, and activate more anatase TiO₂ as the primary disinfecting agent, resulting in the photocatalyst sol-gel becoming more photocatalytic active to a visible light. The mass ratio of TiO₂ to silver nanoparticles at 6.7:1 is outside the 10:1 to 100:1 range defined originally in claim 1 of U.S. patent application Ser. No. 17/352,296. It is thus reasonable to expand the range of the mass ratio of TiO₂ to silver nanoparticles to 2:1 to 100:1, maintaining TiO₂ as the primary photocatalyst.

In one aspect, a self-disinfecting photocatalyst sheet comprises a substrate material with a first side and a second side opposite the first side, and photocatalyst layer comprising a primary photocatalyst and a secondary photocatalyst, and a primer containing either carboxyl groups or carbonyl groups between the first side of the substrate material and the photocatalyst layer. The primary photocatalyst comprises anatase TiO₂ with particle size less than 100 nm, and the secondary photocatalyst comprises a metallic photocatalyst, selected from silver, gold, copper, zinc, nickel, cerium, or a combination thereof. The mass ratio of the primary photocatalyst to the secondary photocatalyst is between 2:1 to 100:1. The secondary photocatalyst absorbs a visible light energy, transfers the energy to the primary photocatalyst, thus activating the primary photocatalyst as the primary disinfecting agent. The substrate material binds the photocatalyst layer by either connecting the primary photocatalyst and/or the secondary photocatalyst through two oxygen atoms of a carboxyl group (COO) comprising the primer, or by forming hydrogen bonds between the carbonyl group and a surface hydroxyl group (OH—) of the primary photocatalyst.

It is noted that TiO₂ itself does not contain any hydroxyl groups. However, it is well known that when TiO₂ is exposed to water vapor or wet air water molecules are easily dissociated to form hydroxyl groups on the surface of TiO₂. See https://www.sciencedirect.com/science/article/abs/pii/S2213343721000580 and https://www.ncbi.nlm.nih.gov/pmc/articles/PMC5459044/ for reference. In the method for producing the self-disinfecting photocatalyst sheet of the present disclosure, a water-based photocatalyst (TiO₂) solution is used, and it can thus easily form hydroxyl groups on the surface of TiO₂. There are methods in forming hydroxyl groups on the surface of TiO₂. One example method is described in https://www.mdpi.com/1996-1944/10/5/566. This method may be used to create the water-based photocatalyst (TiO₂) solution, thus providing rich hydroxyl groups on the surface of TiO₂. Moreover, it is also known that with heat curing, COOH group and TiO₂ can form hydrogen bond and Esterification (see “Homogenous anchoring of TiO₂ nanoparticles on graphene sheets for waste water treatment”, by Kan Zhang, et. al, Materials Letter, 81 (2012), pages 127-130). In the method for producing the self-disinfecting photocatalyst sheet of the present disclosure, a heat curing process is performed after the water-based photocatalyst solution is sprayed on this first side of the substrate material that had already been sprayed with a hydrophilic primer. Consequently, the heat curing process of the proposed method producing the self-disinfecting photocatalyst sheet of the present disclosure can facilitate the forming of hydroxyl groups on the surface of TiO₂.

### BRIEF DESCRIPTION OF THE DRAWINGS

The accompanying drawings are included to aid further understanding of the present disclosure and are incorporated in and constitute a part of the present disclosure. The drawings illustrate a select number of embodiments of the present disclosure and, together with the detailed description below, serve to explain the principles of the present disclosure. It is appreciable that the drawings are not necessarily to scale, as some components may be shown to be out of proportion to size in actual implementation in order to clearly illustrate the concept of the present disclosure.

FIG. 1 shows the picture of two photocatalyst solution samples, Sample A and Sample B.

FIG. 2 shows the FE-SEM analysis of two photocatalyst sol-gel samples.

FIG. 3A, FIG. 3B, and FIG. 3C respectively show the images of the photocatalyst particles of Sample B at a lower magnification (×33,000), at a higher magnification (×65000), and at a higher magnification with a different view (×65,000).

FIG. 4 lists the dynamic light scattering (DLS) results of two photocatalyst sol-gel samples, together with the DLS result of Ag NPs (silver nanoparticles) solution sample.

FIG. 5A, FIG. 5B, and FIG. 5C respectively show MB degradation when samples are exposed with 365 nm UV light at 20 cm distance, MB degradation when exposed to 3433K white light at 819 lux, and MB degradation when exposed to 5000K white light at 312 lux.

FIG. 6 schematically depicts the binding of a substrate material R via two oxygen atoms of a carboxyl group (COO) to an ion Ti4+, an ion Ag+, and an ion Ce3+.

FIG. 7 schematically depicts the binding of a substrate material R via a carbonyl group and a surface hydroxyl group (OH—) of TiO2.

FIG. 8 schematically depicts the functional group of acrylic resin, alkyd resin, and polyurethane with the carboxyl groups highlighted in red.

FIG. 9 schematically depicts a diagram of an embodiment of the present disclosure with adhesive coating on the second side of a substrate material.

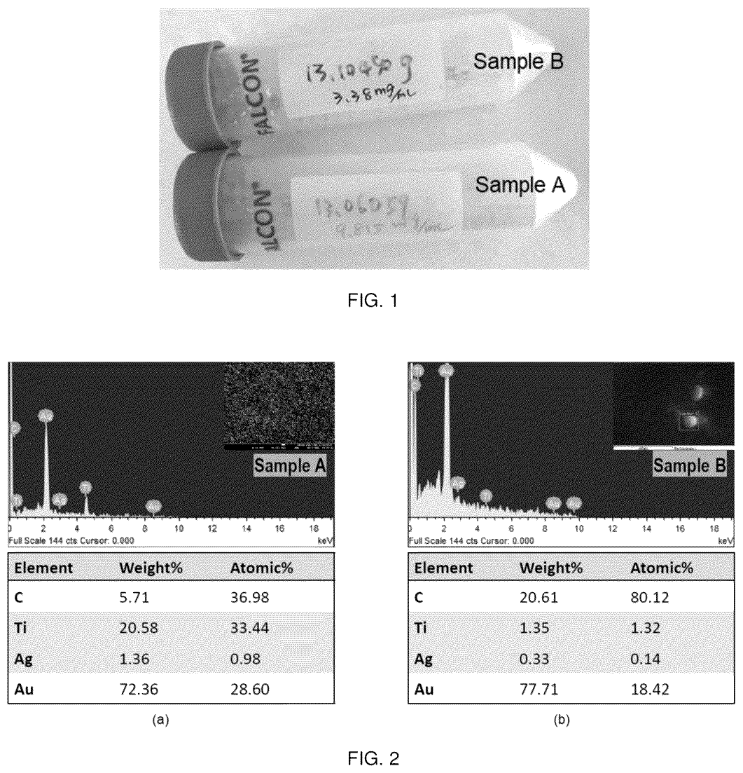

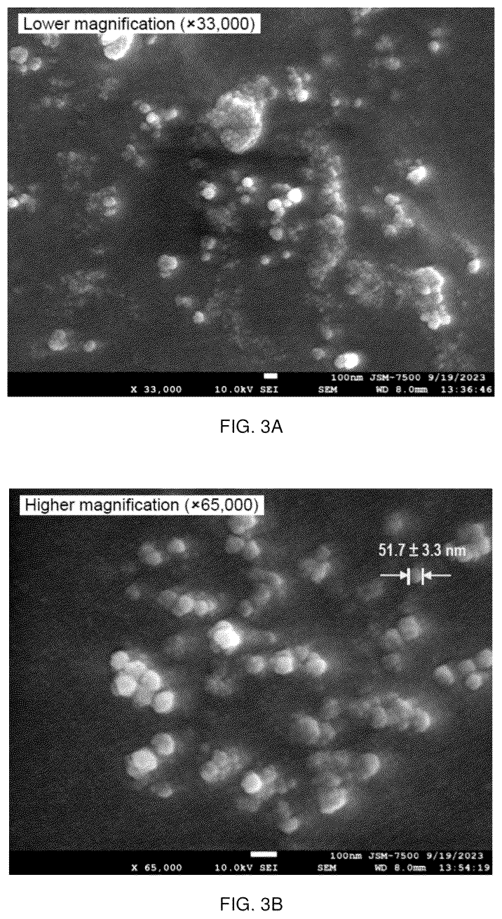

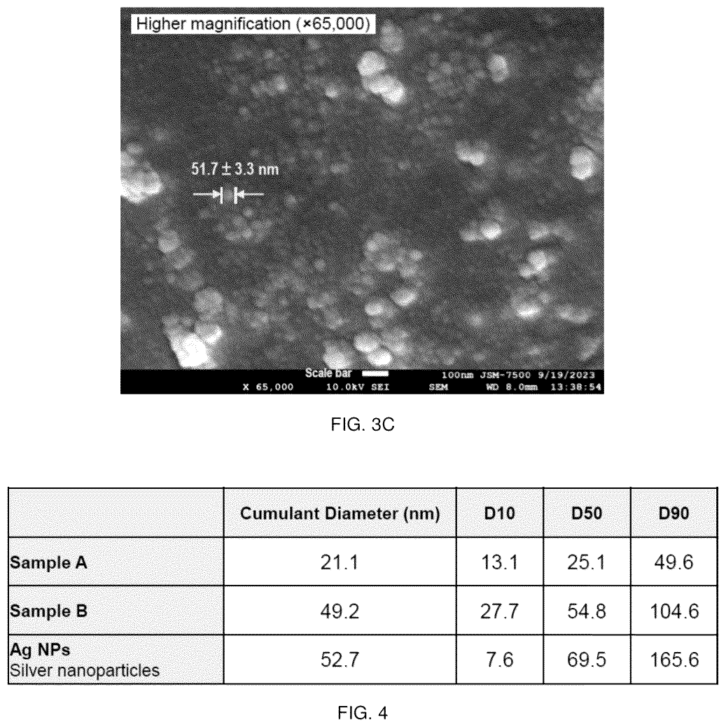

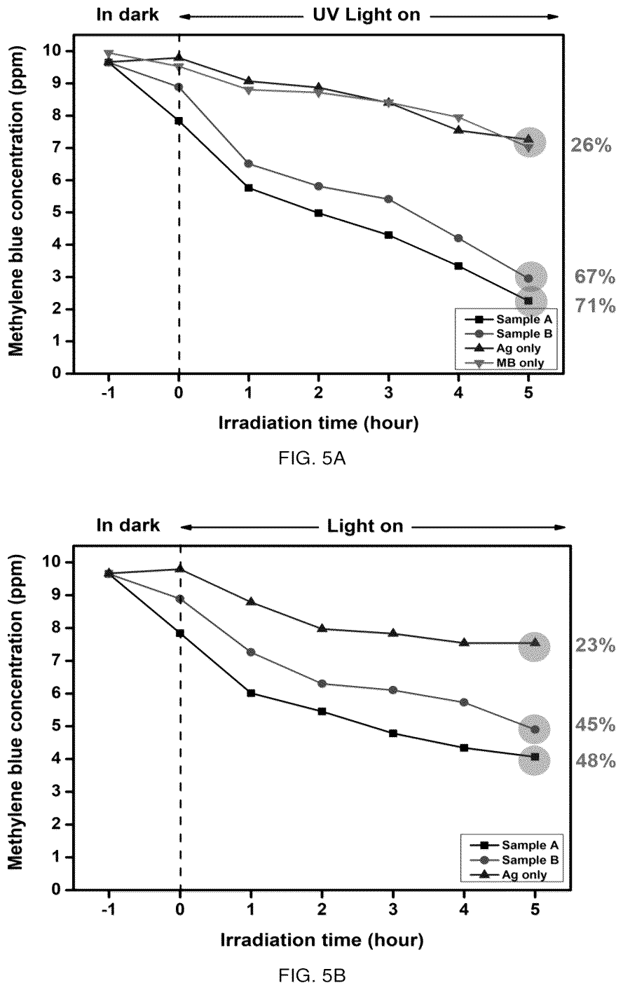

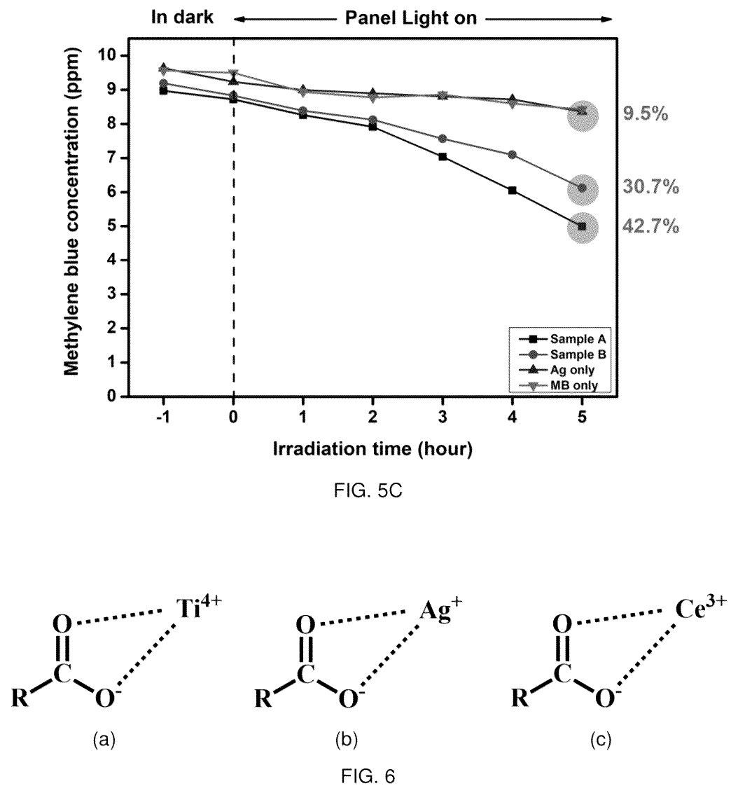

### DETAILED DESCRIPTION OF PREFERRED EMBODIMENTS

### Overview

Various implementations of the present disclosure and related inventive concepts are described below. It should be acknowledged, however, that the present disclosure is not limited to any particular manner of implementation, and that the various embodiments discussed explicitly herein are primarily for purposes of illustration. For example, the various concepts discussed herein may be suitably implemented in a variety of the primary, the secondary photocatalyst, the substrate material, and the hydrophilic primer.

The present disclosure discloses a self-disinfecting photocatalyst sheet includes a substrate material and a photocatalyst layer with a primary photocatalyst and a secondary photocatalyst, and a primer between the substrate and the photocatalyst layer. The primary photocatalyst is anatase TiO₂, whereas the secondary photocatalyst is a metallic photocatalyst. The secondary photocatalyst absorbs a visible light energy, transfers the energy to the primary photocatalyst, thus activating the primary photocatalyst as the primary disinfecting agent. The substrate material binds the photocatalyst layer by either connecting the primary photocatalyst and/or the secondary photocatalyst through two oxygen atoms of a carboxyl group, or by forming hydrogen bonds between a carbonyl group and a surface hydroxyl group (OH⁻) of the primary photocatalyst. The self-disinfecting photocatalyst sheet is activatable by a visible light and can self-disinfect against bacteria and viruses.

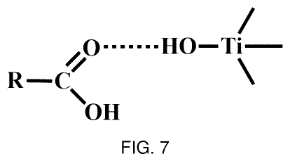

One novel feature of the present disclosure is on how the substrate material connects with the photocatalyst layer. The substrate material may bind the photocatalyst layer by connecting a metal ion of the primary photocatalyst and/or the secondary photocatalyst through two oxygen atoms of a carboxyl group (COO). FIG. 6a shows an example where a primer the carboxyl group can bind strongly with a TiO₂ primary photocatalyst via the connection of an ion Ti⁴⁺ with two oxygen atoms of the carboxyl group (COO—Ti⁴⁺). The ion Ti⁴⁺ may be replaced with Ag⁺ (as shown in FIG. 6b), Ce³⁺ (as shown in FIG. 6c), Au²⁺, Cu²⁺, Fe²⁺, or Zn²⁺ when they are used as the metallic secondary photocatalyst. Alternatively, the substrate material may bind the photocatalyst layer by forming hydrogen bonds between a carbonyl group and a surface hydroxyl group (OH⁻) of the primary photocatalyst, as shown in FIG. 7.

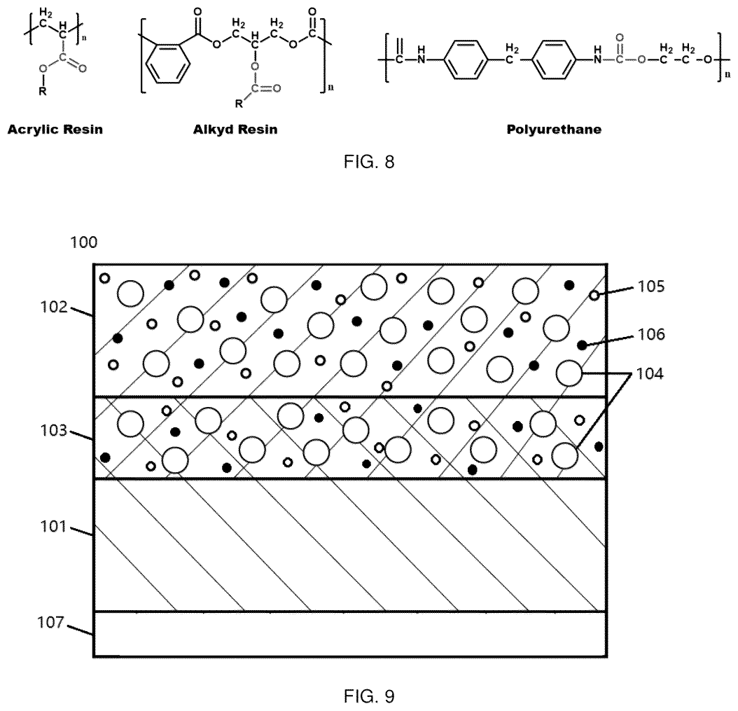

The carboxyl group for binding ion Ti⁴⁺ shown in FIG. 6 or the carbonyl group for binding the surface hydroxyl group (OH⁻) of TiO₂ shown in FIG. 7 may not be part of the natural structure of the substrate material. Rather, they are introduced into the surface structure of the substrate material using some hydrophilic primer, such as acrylic polymers (acrylic resin), alkyd polymers (alkyd resin), and polyurethanes. FIG. 8 shows the functional group of acrylic resin, alkyd resin, and polyurethane with the carboxyl groups highlighted in red.

In some embodiments, an adhesive layer is coated on the second side of the substrate material such that the present disclosure may adhere to a surface for providing self-disinfection protection for that surface.

The secondary metallic photocatalyst may contain one or two or even more metallic photocatalyst materials. In some embodiments, the secondary photocatalyst only comprises two metallic photocatalyst materials, a third metallic photocatalyst and a fourth metallic photocatalyst, with no other metallic photocatalysts. In some embodiments, the third metallic photocatalyst comprises silver nanoparticles (NPs) and the fourth metallic photocatalyst comprises cerium NPs. Both silver NPs and cerium NPs help improve the photocatalytic activity of anatase TiO₂ when illuminated with a visible light. It is found that silver NPs themselves are effective in inhibiting bacteria under a visible light, whereas cerium NPs are effective in inhibiting viruses under a visible light. Having both silver NPs and cerium NPs as the secondary metallic photocatalyst would improve the self-disinfection effectiveness of the present disclosure under a visible light.

In some embodiments, the substrate material comprises a glass. Some of the cellphone screen protectors are made of soda lime glass or alkaline-aluminosilicate glass, and they can be made to be a very thin sheet. They would be good candidates for the substrate material of the present disclosure. A screen protector with a self-disinfecting photocatalytic surface provides the user of the cellphone a continual antimicrobial protection against any germs on the screen protector.

In some embodiments, the substrate material comprises a resin. The resin has been widely used for screen protector, packaging, and surface covering. Some widely used resins include polyvinyl chloride, polyethylene, polyethylene terephthalate, polyurethane, thermoplastic polyurethane, polypropylene, polystyrene, silicone, and other thermoplastic and thermosetting resins.

A method for producing the present disclosure includes the following steps. Step 1 is a surface activation step. In Step 1, a low-temperature atmospheric plasma or a corona treatment is applied to the first side of the substrate material for improving the hydrophilic property of the substrate material. A substrate material such as glass or resin may have a low hydrophilic property by nature. It is difficult to coat water-based solution to the surface of glass or resin. By applying a low-temperature atmospheric plasma or a corona treatment to the substrate material, the hydrophilic property of the substrate material can be greatly improved for a short time for the subsequent coating with a water-based solution. The low-temperature atmospheric plasma may be an oxygen plasma or a nitrogen plasma. The time and the temperature of the atmospheric plasma application would depend on the substrate material. For example, the time may be shorter and the temperature lower when using an atmospheric plasma to surface-activate a resin substrate material, whereas the time may be longer and the temperature higher when using the atmospheric plasma to surface-activate a glass substrate material. In Step 2, a hydrophilic primer containing either carboxyl groups or carbonyl groups is applied on the first side of the substrate material. Acrylic resin, alkyd resin, and polyurethane are good candidates for hydrophilic primer. Step 3 is a surface coating step. In Step 3 a water-based photocatalyst solution is sprayed on the first side of the substrate material evenly. The water-based solution comprises the primary photocatalyst and secondary photocatalyst. The mass ratio of the primary photocatalyst to the secondary photocatalyst is 2:1 to 100:1. Step 4 is a curing step. A heat curing is applied to the substrate material sprayed with the water-based photocatalyst solution so that the substrate material binds the photocatalyst layer by either connecting the primary photocatalyst and/or the secondary photocatalyst through two oxygen atoms of the carboxyl group, or by forming hydrogen bonds between the carbonyl group and a surface hydroxyl group (OH⁻) of the primary photocatalyst. Step 5 is an optional step for coating an adhesive layer on the second side of the substrate material. The adhesive layer may comprise a pressure-sensitive adhesive (PSA) material or an electrostatic-enhancing agent.

### Example Implementations

In FIG. 9, an embodiment 100 of the present disclosure is shown. A photocatalyst layer 102 is coated over a substrate material, polyvinyl chloride (PVC) 101. The photocatalyst layer contains a primary photocatalyst TiO₂ 104 and two secondary metallic photocatalysts, silver nanoparticles (NPs) 105 and cerium NPs 106. During the manufacturing process, a hydrophilic primer, acrylic resin, is used during the coating of the photocatalyst 102 onto the substrate material 101. As a result, on the boundary 103 where the photocatalyst 102 meets the substrate material 101, the bindings of a substrate material R via two oxygen atoms of a carboxyl group (COO) to an ion Ti⁴⁺, an ion Ag⁺, and an ion Ce³⁺ (as shown in FIG. 6) may be seen. With the presence of the two secondary photocatalysts, the photocatalyst layer 102 is activatable by a visible. The second side of the PVC substrate material is coated with an adhesive layer 107 comprising a pressure-sensitive adhesive (PSA) material. With a PSA layer, the embodiment could be used as self-disinfecting window film, and it can be attached, removed, and even reattached to a glass window and provide self-disinfection protection for the glass window.

This embodiment is made first by treating the PVC substrate material 101 with an oxygen plasma at 50° C. Then one side of the plasma-treated substrate material PVC is treated with a hydrophilic primer, acrylic resin, followed by spraying with a water-based TiO₂ solution that also contains silver NPs and cerium NPs. The TiO₂ used is anatase TiO₂. The mass ratio of the secondary photocatalysts, silver NPs and cerium NPs, to the primary photocatalyst TiO₂ is chosen to be 6.7 to 1. The substrate material being sprayed with a water-based TiO₂ solution goes through a heat curing process for 30 minutes at 150° C. Lastly, the second side of the PVC substrate material is coated with an adhesive layer comprising a pressure-sensitive adhesive (PSA) material.

Additional and Alternative Implementation Notes

Although the techniques have been described in language specific to certain applications, it is to be understood that the appended claims are not necessarily limited to the specific features or applications described herein. Rather, the specific features and examples are disclosed as non-limiting exemplary forms of implementing such techniques.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

What is claimed is:

1. A self-disinfecting photocatalyst sheet, comprising:
a substrate material with a first side and a second side opposite the first side;
a photocatalyst layer comprising a primary photocatalyst and a secondary photocatalyst; and
a primer containing either carboxyl groups or carbonyl groups between the first side of the substrate material and the photocatalyst layer,
wherein:
the primary photocatalyst comprises anatase titanium dioxide with a particle size less than 100 nm,
the secondary photocatalyst comprises a metallic photocatalyst selected from silver, gold, copper, zinc, nickel, cerium, or a combination thereof,
a mass ratio of the primary photocatalyst to the secondary photocatalyst is between 2:1 to 100:1,
the secondary photocatalyst absorbs a visible light energy, transfers the visible light energy to the primary photocatalyst, thereby activating the primary photocatalyst as a primary disinfecting agent, and
the substrate material binds the photocatalyst layer by either:
connecting either or both of the primary photocatalyst and the secondary photocatalyst through two oxygen atoms of a carboxyl group (COO) comprising the primer, or
forming hydrogen bonds between the carbonyl groups and a surface hydroxyl group (OH—) of the primary photocatalyst.

2. The self-disinfecting photocatalyst sheet of claim 1, further comprising an adhesive layer which is coated on the second side of the substrate material.

3. The self-disinfecting photocatalyst sheet of claim 1, wherein the secondary photocatalyst further comprises a third metallic photocatalyst and a fourth metallic photocatalyst with no other metallic photocatalysts, and wherein the third metallic photocatalyst and the fourth metallic photocatalyst are selected from silver, gold, copper, zinc, nickel, and cerium.

4. The self-disinfecting photocatalyst sheet of claim 3, wherein the third metallic photocatalyst comprises silver nanoparticles (NPs) and the fourth metallic photocatalyst comprises cerium NPs.

5. The self-disinfecting photocatalyst sheet of claim 1, wherein the substrate material comprises a glass.

6. The self-disinfecting photocatalyst sheet of claim 1, wherein the substrate material comprises a resin.
